(19) United States
(12) Patent Application Publication
(10) Pub. No.: US 2008/0007911 A1
(43) Pub. Date: Jan. 10, 2008

(54) Apparatus Casing

(75) Inventors: Ingemar Hallin, Lidingo (SE); Jan Blomberg, Stockholm (SE); Bjorn Flemsater, Lidingo (SE); Anders Bergqvist, Stockholm (SE)

Correspondence Address: PEARNE & GORDON LLP, 1801 EAST 9TH STREET, SUITE 1200, CLEVELAND, OH, 44114-3108, US

(73) Assignee: DOMETIC SWEDEN AB, Solna (SE)

(21) Appl. No.: 11/722,409

(22) PCT Filed: Dec. 21, 2005
(86) PCT No.: PCT/SE05/01993

§ 371 Date: Sep. 17, 2007

(30) Foreign Application Priority Data
Dec. 22, 2004 (SE) 0403126-6

(51) Int. Cl. G06F 1/20

(52) U.S. Cl. 361/687; 361/685

(57) ABSTRACT

The present invention relates to an apparatus casing for a computer, comprising a number of walls (21, 22, 23, 24, 101, 103, 104, 105, 106, 107) which together define a first chamber (20, 200) for accommodating computer components (A, B, C), a noise attenuating inlet (30) which includes an inlet duct (31, 310) and an inlet opening (32, 320) that opens into the first chamber for supplying air from the surrounding atmosphere to the first chamber via the inlet duct and the inlet opening, a noise attenuating outlet (40) which includes a first outlet opening (42, 420) and an outlet duct (41, 410) for dispelling air from the first chamber to the surrounding atmosphere via the first outlet opening and the outlet duct, and a fan (45, 450) for producing an air flow through the inlet, the first chamber and the outlet. The invention also relates to a computer that includes one such apparatus casing.

### FIELD OF THE INVENTION

The present invention relates to an apparatus casing or box for a computer and comprising a number of walls which together delimit a first computer components accommodating chamber which has a first air inlet opening and a first air outlet opening, a noise damping inlet which communicates with the first chamber via the first inlet opening and which includes an inlet duct for delivering air from the surrounding atmosphere, a noise attenuating outlet which communicates with the first chamber via the first outlet opening and which includes an outlet duct for expelling air to the surrounding atmosphere, a fan or blower for achieving a total f low of air through the inlet and through the first chamber and said outlet. The invention also relates to a computer that is equipped with such a casing.

The invention is particularly suitable for use with stationary personal computers and server computers.

### BACKGROUND OF THE INVENTION

The requirement for improved performance of personal computers and servers often results in higher power consumption and therewith in more heat generated by the computer components. For example, in the case of typical processors the heat generated has increased in the last decennium from a typical magnitude of about 10-20 W to about 75-100 W. Among other things, this constantly heightens the need to cool the components and therewith also the computers equipped therewith. Personal computers and servers are typically cooled with the aid of fans or blowers that generate a flow of air within the box or casing, wherewith the air takes up heat from the components as it flows in contact therewith and transfers this heat to the surroundings. One problem with this solution is that the fans/blowers and the air flow result in noise which is both disturbing and ergonomically disadvantageous to the user and to persons in the vicinity. A great deal of development work has been laid down in an effort to reduce the level of noise in operation and, at the same time, to achieve sufficient cooling. For example, blowers or fans that have a low and variable speed have been used. Generally, however, there is a logical incongruity between the desire to use high performance components that require effective cooling and to maintain the operational noise at a low level. Consequently, it has been necessary to ignore the low noise requirement, particularly in the case of modern stationary high-performance personal computers and servers.

### DESCRIPTION OF THE PRIOR ART

U.S. Pat. No. 5,452,362 describes an apparatus box for computers. The box includes an inlet duct, a computer component accommodating chamber, and an exhaust duct. The inlet and exhaust ducts are provided with noise attenuating means for preventing noise from passing from the chamber to the external surroundings of the box. A fan is provided within the chamber for generating an air flow through the inlet duct, the chamber and the exhaust duct for cooling of the components in the chamber. The invention described in U.S. Pat. No. 5,452,362 relates to a method and to apparatus for reducing noise generated in the chamber as a result of cooling said components to the greatest possible extent. The document proposes that the inlet and exhaust ducts are provided with means in the form of a so-called anti-noise circuit for active attenuation of the noise signal. This anti-noise circuit registers the noise occurring in the chamber and generates a corresponding noise signal that is similar to the original noise signal but is said to be phase shifted through 90° in relation to the original signal. The aim is to produce an effect which is said to cause a reduction in the acoustic signature of the noise discernible to an observer externally of the chamber. The described anti-noise circuit includes a microphone that registers samples and analyses the original sound, and a transducer which generates the phase shifted cancellation of sound signals. According to one embodiment the transducer may comprise a loudspeaker while according to another embodiment either a wall in the exhaust duct or the exhaust duct itself may consist of a piezo-resistive or magneto-resistive material that is able to generate the cancelling noise.

As will be obvious from the above, the apparatus described in U.S. Pat. No. 5,452,362 is relatively complicated and requires the computer to be provided with further electronic and mechanically moveable components. The described apparatus thus renders the computer significantly more expensive while, at the same time, increasing the risk of malfunctioning or computer crashes and renders access for computer servicing and for the replacement of computer components more difficult.

### BRIEF DESCRIPTION OF THE DRAWINGS

The present invention is based on the insight that different computer components require different degrees of cooling and that the configuration of the air flow paths within the apparatus casing of a computer are of decisive significance in respect to achieving a satisfactory cooling of the components in the casing with the aid of limited flow volumes.

One object of the present invention is to provide an apparatus casing in which modern high performance components can be mounted and which enables the computer to emit sound of only an extremely low volume in operation.

Another object of the invention is to provide such an apparatus casing with which the volume of the noise emitted from the casing can be maintained at a very low level while ensuring satisfactory cooling of sensitive components with which a large amount of heat is developed.

Another object of the invention is to provide such an apparatus casing with which effective attenuation of the noise generated in the casing is also achieved with a relatively high air flow through the casing.

Another object of the invention is to provide such an apparatus casing which can be manufactured relatively simply and cheaply and which requires only a small amount of space and which can be readily accessed for service and replacement of box-mounted components.

Still another object of the present invention is to provide such an apparatus casing in which commercially available standard components can be mounted without needing to adapt the casing or the components.

Still another object of the present invention is to provide such an apparatus casing in which standard components can be placed in positions that are conventional in respect of stationary personal computers and servers.

These and other objects of the present invention are achieved with an apparatus casing of the kind described in the first paragraph of this description and which has the special features set forth in the characterizing clause of the accompanying claim 1.

According to one important aspect of the invention, the chamber is generally delimited hermetically from the surroundings with the exception of the noise attenuating inlet and outlet. This counteracts the passage of operational noise caused by tans, hard discs, cd-units-and dvd-units and other noise generating components out to the casing surroundings.

Another important aspect is that the total flow of cooling air in the bottom flow part of the chamber is divided into two separate sub-flows and that a component can be placed in one of said sub-flows. The inventors are aware that it is primarily the motherboard and associated Central Processing unit (CPU), Hard Disc Drive (HDD) and the graphics board that require especially effective cooling and that emit a particularly large amount of heat to the cooling flow. These and any other components that emit large quantities of heat can thus be considered as heat-wise critical components. Modern high performance computers will normally include a plurality of hard discs that are collected in a hard disc pack, which thus constitutes one such critical component.

By placing a first of these critical components in one separate sub-flow it will be ensured that air that has swept across this first critical component and absorbed heat therefrom will not pass to another critical component prior to the air being exhausted from the chamber. It is thereby ensured that this other critical component will be cooled constantly with air that has not taken up heat from the first critical component. Because the air flow to this other critical component has not been heated by the first critical component, said other critical component being cooled satisfactorily even when this flow volume is kept low. This also enables the total flow of air through the apparatus casing to be kept low while still ensuring satisfactory cooling of the components mounted in the apparatus casing. As a result of this relatively low total volume of air passing through the casing, the noise generated in the casing will also be low, while, at the same time, keeping the energy consumed by the fans driving the cooling air at a low level. As a result of the effective control of the air flow through the apparatus casing, the flow sound generated by a given air flow will also be significantly lower than would otherwise have been possible. As a result, and because the air flow through the casing is optimised, it is also possible that computers which include components that generate large amounts of heat and that require relatively large air flows, can be operated with acceptable noise levels.

Thus, the apparatus casing according to the present invention enables a very quiet computer containing high performance components that are cooled satisfactorily to be readily constructed. The apparatus casing according to the present invention enables a significantly lower noise level to be achieved in comparison with earlier known computers of corresponding performance.

Other objects of the present invention and advantages afforded thereby will be evident from the following dependent claims. The invention also relates to a computer that has such an. apparatus casing, in accordance with claim 8.

### DETAILED DESCRIPTION OF EXEMPLIFYING EMBODIMENTS

Exemplifying embodiments of the present invention will now be described with reference to the accompanying drawings, in which

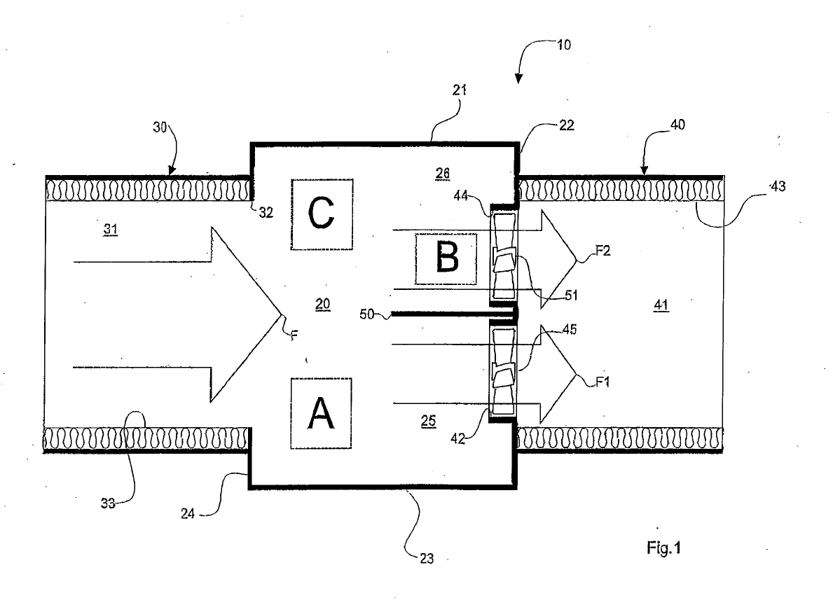

FIG. 1 is a schematic explanatory drawing that illustrates the invention;

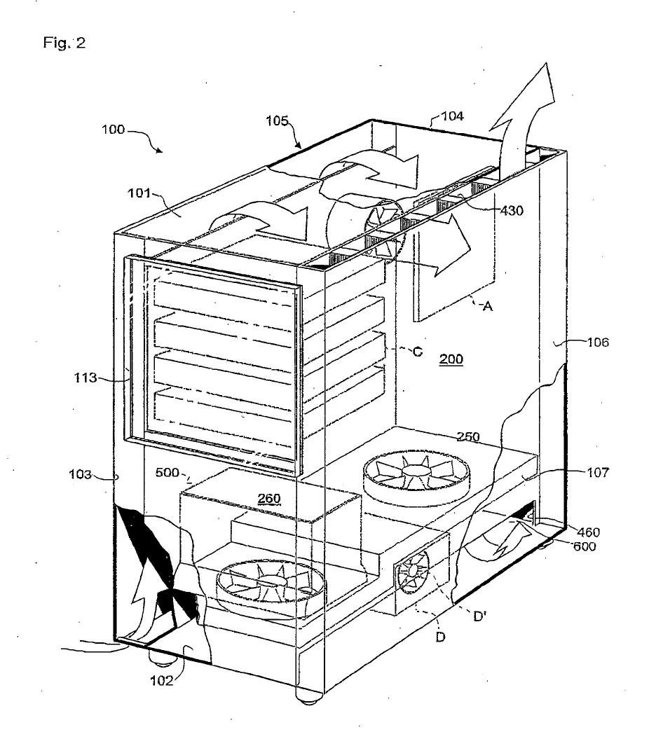

FIG. 2 is a partially broken perspective view of one embodiment of an apparatus casing or box according to the invention;

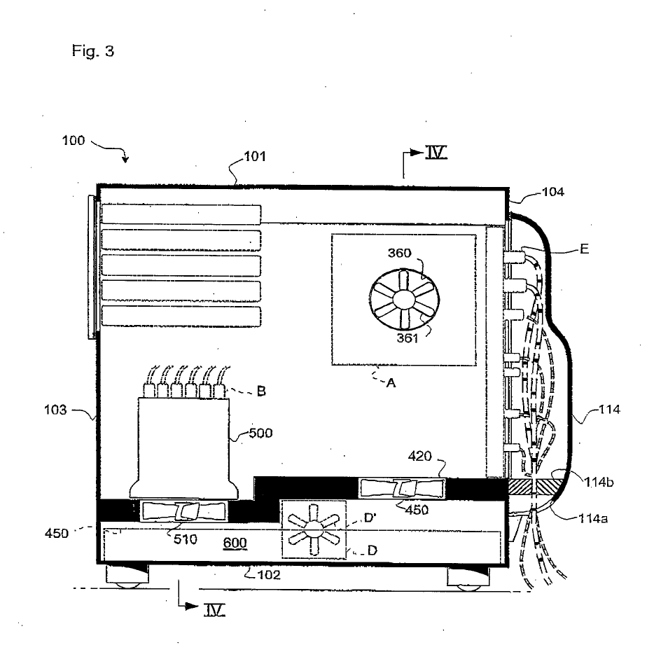

FIG. 3 is a sectioned side view of the apparatus casing shown in FIG. 2;

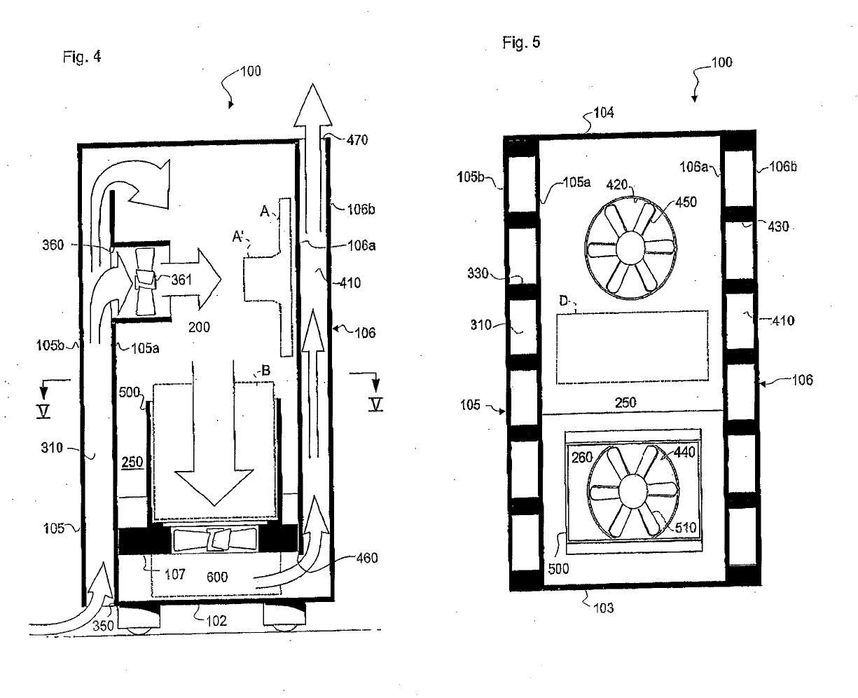

FIG. 4 is a sectional view taken on the line IV-IV in FIG. 3; and

FIG. 5 is a sectional view taken on the line V-V in FIG. 4.

The explanatory drawing in FIG. 1 illustrates schematically an apparatus casing 1 that includes a chamber 20, an inlet 30 and an outlet 40. The chamber 20 is delimited by a number of defining walls 21, 22, 23, 24 essentially hermetically from the surroundings, with the exception of via the inlet 30 and the outlet 40. A number of computer components A, B, C are disposed in the chamber 20. The components A and B are critical components from a heat-technical aspect, i.e. components which develop relatively large amounts of heat in operation and which require effective cooling in order to function without problems. In the case of the illustrated embodiment, the critical component A may consist of a mother card with a central processing unit, whereas the critical component B may consist of a hard disc pack comprising a number of hard discs. The non-critical component C may consist of one or more discs, CD: s and/or DVD: s, which generate less heat and which therefore require less cooling than the heat critical components.

The inlet 30 includes an inlet duct 31 and an inlet opening 32 which is disposed in a first defining wall 24 and through which the inlet duct 31 opens into the chamber 20. The inlet duct 31 includes noise absorbing material 33 which counteracts noise generated in the chamber 20, in the outlet 40 and in the inlet 30, this noise passing to the surroundings to the inlet 30. The outlet 40 includes an outlet opening 42 which is disposed in a second defining wall 22 and through which the chamber 20 communicates with an outlet or exhaust duct 41 which, correspondingly, also includes noise absorbing material 43.

A first exhaust fan 45 is mounted in the first exhaust opening 42 so as to generate a flow of air through the inlet 30, the chamber 20, the first exhaust opening 42 and the exhaust duct 41.

According to the invention, the exhaust duct 40 includes a second exhaust opening 44 which is located in the second defining wall 22 and through which the chamber 20 is able to communicate with the exhaust duct 41. According to the invention means are provided in the downstream part of the chamber, i.e. the chamber part close to the exhaust openings 42, 44, such as to divide the total air flow through the chamber into two mutually separated sub-flows. In the case of the embodiment shown in FIG. 1, said means consist in a partition wall 50 and in a second exhaust fan 51 arranged in the second exhaust opening 44. The partition wall 50 is fixedly connected to the second defining wall 22 between the first and the second exhaust openings respectively and extends over the full depth of the chamber in a direction at right angles to the plane of the figure in FIG. 1. The partition wall 50 also extends from the second defining wall 22 into the chamber 20 to some extent, such as to divide the downstream part of the chamber 20 into two sub-chambers 25, 26, which are both open to the upstream part of the chamber 20.

When both of the exhaust fans 45, 51 are in operation, the total air flow F through the chamber 20 will be divided into two mutually separate sub-flows F1, F2 in the downstream part of the chamber, these sub-flows passing through respective sub-chambers 25 and 26 and respective exhaust openings 42 and 44. According to the present invention, the apparatus casing is provided with means for securing a critical component B in one sub-flow 72. This will ensure that the sub-flow F2 which comes into contact with the critical component B is unable to pass any other critical component after having swept across the component B. Thus, there is no danger of the critical component A being swept by air that has already swept across the critical component B. Because the temperature of the air cooling the critical component A is kept at a low level in this way, cooling of the component will be highly effective, enabling the total air flow F through the apparatus casing to be kept low.

As indicated in FIG. 1 the predominant part of the air that has swept across the critical component A will exit through the first exhaust opening 42. The best result is obtained when the fans are balanced so that essentially all air that has swept across the critical component A exits through the first exhaust opening 42 and therewith does not pass across the critical component B. The component B will then be cooled by air that has not swept across any other component and air which has solely swept across the non-critical component C, which gives off less heat than the critical component A. It has been observed, however, that even if a part of the air which has swept across the critical component A also sweeps across the critical component B that relatively effective cooling of the component B is also achieved, so as to enable the total air flow through the apparatus casing to be kept relatively low.

In order to enable the total air flow through the apparatus casing to be reduced and therewith reduce said noise it is sufficient in accordance with the invention to prevent air that has swept across the critical component to sweep over another critical component. In order to further reduce the total air flow through the apparatus casing, it is also desirable to prevent air that has swept across a critical component from passing across another critical component.

A preferred embodiment of the apparatus casing according to the present invention will now be described with reference to FIGS. 2-5.

The apparatus casing 100 shown in FIGS. 2-5 includes a number of walls, consisting of a top wall 101, a bottom wall 102, a front wall 103, a rear wall 104, and two opposing sidewalls 105, 106. Each of the sidewalls 105, 106 is double-walled, i.e. they form a cavity wall, such as to provide an inlet duct 310 within the side wall 105 and to provide an exhaust duct 410 within the side wall 106. A number of noise absorbing baffles 330 and 430 respectively are mounted in the inlet duct 310 and the exhaust 410 respectively. The baffles are comprised of sound absorbing material, such as polyester foam. In the case of the illustrated example, the baffles 330, 430 are disposed so as to form longitudinally extending channels within respective sidewalls 105, 106. The baffles may also be arranged to form one or more curved channels within the sidewalls.

Also arranged in the apparatus casing 100 is a horizontal chamber wall 107, such as to divide the casing interior into a first chamber 200 and a second chamber 600. The upper chamber is delimited by the top wall 101, the chamber wall 107 and upper portions of the front wall 103, the rear wall 104 and by the inner walls 105a, 106a of the double sidewalls 105, 106. The second chamber 600 is delimited correspondingly by the bottom wall 102, the chamber wall 107 and lower portions of the front wall 103, the rear wall 104 and by the inner sides 105a, 106a of the double sidewalls 105, 106.

The inlet duct 310 includes an inlet orifice 350 disposed in the lower end of the double sidewall 105, between its inner and outer walls 105a and 105b, respectively. The inlet orifice 150 extends over essentially the full width of the sidewall 105. The inlet duct 310 also includes a primary inlet opening 320 with which it opens into the first chamber 200. The primary inlet opening 320 is comprised of an aperture in the upper end of the inner wall 105a of the double side wall 105 and extends generally over the full width of the sidewall 105. The inlet duct 310 also includes a secondary inlet opening 360 that has the form of a cylindrical opening and that is located somewhat below the primary inlet opening 320 in the inner wall 105a of the double sidewall 105 and extends inwardly in the first chamber 200 front the inner wall 105a. An inlet fan 361 is provided in the circular opening.

The exhaust duct 410 communicates with the second chamber 600 via a chamber opening 460 comprised of an aperture in the lower end of the inner wall 106a of the side wall 106 and extends generally over the full width of the side wall 106. The exhaust duct 410 communicates with the surrounding atmosphere via an exhaust orifice 470 located in the upper end of the double side wall 106, between its inner wall 106a and its outer wall 106b. The exhaust orifice 460 extends generally over the full width of the sidewall 106.

The chamber wall 107 includes a first circular exhaust opening 420 through which the first chamber 200 communicates with the second chamber 600. There is included in the first exhaust opening 420 a first exhaust fan 450 for expelling air from the first chamber 200 to the second chamber 600. The chamber wall 107 includes a second circular exhaust opening 440 through which the first chamber 200 communicates with the second chamber 600. A second exhaust fan 510 is provided in the second exhaust opening 440 for driving air from the first chamber 200 to the second chamber 600.

The first chamber 200 thus communicates with the surrounding atmosphere via the inlet consisting of the inlet orifice 350, the inlet duct 310, the primary inlet opening 320 and the secondary inlet opening 360 and via the exhaust outlet consisting of the first exhaust opening 420 and the second exhaust opening 440, the second chamber 660, the chamber opening 460, the exhaust duct 410 and the exhaust orifice 470. The second chamber 600 can thus be said to constitute a common exhaust plenum for the air that leaves the first chamber 200 through the first exhaust opening 420 and the second exhaust opening 440.

The apparatus casing illustrated in the embodiment shown in FIGS. 2-5 accommodates a plurality of computer components. These components include a motherboard A, a number of discs, CD: s and DVD: s C and a hard disc pack B comprising five hard disc units. These components are arranged in the first chamber 200. The motherboard A has a typical placement on the inside of the sidewall 106 in the upper part of the apparatus casing 100. The secondary inlet opening 360 of the inlet duct 310 is disposed opposite the central processing unit CPU and includes cooling flanges or its own fan A′ which is placed on the motherboard. There is provided in the second chamber 600 a power supply unit (PSU) D that has a fan D′ integrated therewith. Diskettes, CD: s and DVD: s C are disposed typically in openings in the front wall 103 of the apparatus casing 100 such as to enable external insertion and removal of storage media. In order to prevent noise from penetrating through these openings, the front wall 103 is provided with a tightly sealing cover 113 which, when closed, covers these openings. A number of connections are arranged at openings in the rear wall 104 of the casing 100 in a typical fashion. A number of cables E having corresponding electric contacts which are connected to said connections in order to prevent noise from penetrating through these connection openings, a removable sealing hood 114 is provided on the rear wall 104 around said connection openings. The hood 114 includes a cable transit opening 114a and a tightly sealing clamping device 114b which is made of a resilient material and which sealingly encloses the cables E.

The first chamber 200 is thus delimited hermetically from the surrounding atmosphere, except via the inlet to and the outlet from the first chamber 200.

There is arranged on the chamber wall 107 around the second exhaust opening 440 a partition wall 500 which projects slightly up from the chamber wall 107 and into the first chamber 200. The partition wall 500 is formed as a channel of rectangular cross-section. The upstream orifice of the channel is disposed in the first chamber and its downstream orifice consists of the second exhaust opening 440. The channel is thus delimited from a first sub-chamber 250 in a flow-technical fashion, this first sub-chamber 250 being comprised of that part of the first chamber 200 located outwardly of the partition wall 500 and below the upper end of said partition wall. The downstream part of the first chamber 200 is thus divided into the first sub-chamber 250 and into a second sub-chamber 260 consisting of the channel defined by the partition wall 500.

Although not shown, the partition wall 500 is provided with fasteners for firmly securing the five hard disc units B in the second sub-chamber 260. The fasteners are configured so that the long axis of the hard disc units B will be generally parallel with the longitudinal direction of the channel and so that the hard disc units will be secured in spaced relationship with respect to each other and also with respect to the surrounding partition wall 500, so as to allow air to pass freely along the units B.

When the first exhaust fan 450 and the second exhaust fan 510 are running, air is drawn from the surroundings through the inlet to the first chamber 200. A substantial part of the air supplied is delivered through the primary inlet opening 320 to the upper part of the chamber. Because the primary inlet opening extends over the full width of the sidewall 105, the air is distributed across the full width of the chamber (parallel with the plane of FIG. 3). By driving the inlet fan 361, a part of the air delivered from the inlet channel 310 is deflected via the secondary inlet opening 360 directly onto the cooling flange of the central processing unit or its own fan A′ on the motherboard A. This results in effective dedicated cooling of the heat critical central unit on the motherboard A with non-heated air.

The air delivered through the primary inlet opening 320 and the secondary inlet opening 360 respectively is driven by the first exhaust fan 450 and the second exhaust fan 510 down through the first chamber 200. Because the primary inlet opening 320 is elongate and because the two exhaust fans 450, 510 are mutually juxtaposed at the opposite end of the chamber 200, there is achieved a relatively homogenous and uniform flow of air across the horizontal cross-section of the first chamber 200 along the whole of its height.

The air delivered through the left half of the elongate primary inlet opening 320 (see FIG. 3) passes generally down over the components that are non-critical from a heat/technical aspect, i.e. the diskettes, CD:s and DVD:s C and therewith takes up heat from these components. The second exhaust fan 510 then drives this air in a downstream direction towards and into the second sub chamber 260 where it passes over the hard disc pack B, which is critical from a heat/technical aspect, and absorbs heat from said pack. This air exists through the second exhaust opening 440 to the second chamber 600, which constitutes an exhaust plenum.

The air delivered through the right half of the elongate primary inlet opening 320 (see FIG. 3) passes generally down over the heat critical motherboard A and is mixed with the air delivered via the secondary inlet opening 360. After having absorbed heat from the motherboard A and its central processing unit, the air mixture is driven by the first exhaust fan 450 in a downstream direction, down towards and out through the first exhaust opening 420 and into the second chamber 600, where it is mixed with the air that exits through the second exhaust opening 440.

The embodiment illustrated in FIGS. 2-5 thus causes the flow to be divided into two mutually separate sub flows, in the downstream part of the first chamber by the channel-like partition wall 500 and the two exhaust fans 450, 510. Because the heat critical hard discs C are placed within the channel-shaped partition wall 500 it is ensured that air that has absorbed heat from the hard discs C cannot pass other heat critical or non-critical components placed in the first chamber 200.

By balancing the driving force of the first exhaust fan 450 and the second exhaust fan 510 and the inlet fan 361 in relation to one another it is also possible to control the total air flow in all essential aspects and cause it to flow through the first chamber so that the part of the flow that passes said non-critical components C will exit through the second exhaust opening 440 and be kept generally separate from that part of the air flow which passes the motherboard A, this latter part of the air flow exiting generally through the first exhaust opening 420. This prevents air that has absorbed heat from the motherboard A from subsequently passing the hard discs. Such balancing of the fan driving forces thus results in a beneficial flow distribution also in the upstream part of the first chamber therewith enabling a further reduction in the total flow volume through the apparatus casing and also further sound reduction.

In the second chamber 600, which constitutes an exhaust assembly, the air that has exited through the first exhaust opening 420 and the second exhaust opening 440 is again mixed. At least a part of this air mixture is caused to pass the power supply unit D by its integrated fan D′ for cooling of said unit. Because the power supply unit D is not a heat critical component the unit will be cooled sufficiently despite being swept across by air that has absorbed heat from the upstream components.

Subsequent to having swept across the power supply unit D, the heated air is driven out to the surrounding atmosphere through the exhaust channel 410.

The described beneficial flow distribution in the apparatus casing thus contributes towards reducing noise, by ensuring that a fully satisfactory cooling is achieved with the aid of a low total volume flow through the apparatus casing. This low volume flow generates per se a low sound volume as it flows through the casing. Furthermore, the speed at which the fans generating the low volume flow can be kept low, wherewith the noise generated by the fans will also have a low volume.

In addition to the beneficial flow distribution, the sound traps formed by the corners at the inlet 30 and the outlet 40 around which the air is forced to flow also contribute towards preventing airborne sound from exiting from the apparatus casing to the surroundings. Moreover, the hermetical enclosure of the first chamber 200 also greatly contributes towards preventing the exit of airborne operational sound. The sound absorbing baffles 330, 430 in the inlet duct 310 and the exhaust duct 410 respectively also contribute greatly towards reducing the airborne noise from reaching the surroundings.

The design of the apparatus casing exemplified in FIGS. 1-5, however, also includes special properties which greatly reduce the structure-borne sound that reaches the surroundings. Firstly, the double-walled sidewalls 105, 106 are instrumental in stiffening the casing 100 and increasing its mass and also essentially prevent vibrations from moveable components generating disturbing structure-borne noise. The double-walled sidewalls also enable components that include moveable parts, such as a motherboard which has integrated therewith a tan for cooling the central processing unit, to be mounted on the inner side of a double-walled wall without the risk of the vibrations generated by the integrated fan propagating directly through the wall to the surroundings, which would otherwise be the case if moveable components were mounted on single-sided side walls. Secondly, the horizontal chamber wall 107 also stiffens the apparatus casing 100 and therewith essentially prevents vibrations from generating disturbing structure-borne noise. The chamber wall 107 also provides a splendid base for mounting components that include moveable parts. Since the chamber wall 107 extends between the casing defining walls any vibrations or structure-borne noise generated by the moveable components mounted on the chamber wall will be forced to travel along a relatively long propagation path before reaching the surroundings through any of the casing defining walls. This relatively long propagation path results in effective attenuation of such vibrations. In the case of the embodiment illustrated in FIGS. 1-5, the vibration attenuating or damping effect of a chamber wall 107 has been utilized by mounting the two exhaust fans 450, 510 and the strongly vibration generating hard discs B so that the vibrations generated by these components are forced to pass the chamber wall 107 before they can exit through the casing defining walls.

### EXPERIMENT

An experiment was carried out with the intention of comparing the sound generated when using an apparatus casing according to the present invention with the noise generated by a reference casing constructed according to known technology. The apparatus casing according to prior art technology constituted a part of a floor mounted stationary personal computer which had been acclaimed in the journal PC for Allas ? as the winner of a quietest computer competition (No. 9, 2002).

In this experiment, the first computer was run with the reference object for 1.5 hours under a hard load, whereafter the noise level in the frequency range of 6,3 Hz to 20 kHz was measured 107 cm above the floor and 50 cm from the front, rear and both sidewalls of the apparatus casing. The temperature of four critical components and noise within the apparatus casing was also measured.

Because the experiment was intended to compare precisely the effect of the casing on the noise generated in operation, all computer components, such as hard discs, motherboard, CPU, etc. together with all spot cooling ? were transferred from the reference object to the inventive apparatus casing. This transfer excluded a 1 cm-thick damping matt arranged on the inside of the reference object and a hard disc fastening construction.

Subsequent to having run the thus assembled computer with the apparatus casing according to the present invention for 1,5 hours under the same heavy load, the same measurements were carried out with respect to noise level and temperature. The following results were obtained:

| | |
|---|---|
| Apparatus casing | |
| acc. the invention | Reference object |

Noise level (dBA)

| | | |
|---|---|---|
| Front side | 23 | 28 |
| Side 1 | 25 | 28 |
| Rear side | 23 | 32 |
| Side 2 | 25 | 28 |

Temperature (° C.)

| | | |
|---|---|---|
| CPU | 45 | 49 |
| Zone 1 | 35 | 37 |
| Zone 2 | 34 | 35 |
| Hard disc | 42 | 41 |

As will be evident from the measuring results above, the noise level of the inventive apparatus casing was much lower than that of the reference object, and that the measured temperatures was somewhat lower or generally the same as the apparatus casing according to the invention.

Although the invention is described above with reference to two exemplifying embodiments thereof shown in respective figures, it will be understood that the invention is not restricted to these embodiments and that variations can be made within the scope of the accompanying claims. For example, the inlet opening 360 and associated inlet fan 361 in the embodiment illustrated in FIGS. 2-5 can be omitted if considered appropriate, although such omission will reduce the dedicated direct cooling of the central processing unit of the motherboard. However, there will beneficially be achieved through the first chamber an air flow which is more homogeneous and uniform across the horizontal cross-section of the chamber throughout the full height of the chamber.

It will also be understood that minor deviations from the fully hermetic first chamber can be made, provided that the air flow within the chamber between the inlet and the outlet will not be affected to any great extent.

The apparatus casing may be constructed such that both the inlet duct and the exhaust duct are positioned outside one another or on mutually juxtaposed in one and the same wall.

1. An apparatus casing for a computer, comprising a number of walls (21, 22, 23, 24, 101, 103, 104, 105, 106, 107) which together define a first chamber (20, 200) for accommodating computer components (A, B, C);
a noise attenuating inlet (30) which includes an inlet duct (31, 310) and an inlet opening (32, 320) which opens into the first chamber for delivering air from the surrounding atmosphere to the first chamber via the inlet duct and the inlet opening;
a noise attenuating outlet (40) which includes a first outlet opening (42, 420) and an outlet duct (41, 410) for delivering air from the first chamber to the surrounding atmosphere via the first outlet opening and the outlet duct; and
a fan (45, 450) for producing an air flow through the inlet, the first chamber and the outlet,
characterised in that
the first chamber (20, 200) is delimited substantially hermetically from the surrounding atmosphere with the exception of the inlet and the outlet,
the first chamber has a second outlet opening (44, 440) through which the first chamber communicates with the outlet (40),
means are provided in a downstream part of the first chamber for dividing the total flow into two separate sub-flows (F1, F2) which leave the first chamber through the first outlet opening (42, 420) and the second outlet opening (44, 440) respectively, and
in that the casing includes means for securing a computer component (B) in one of the two mutually separate sub-flows.

2. An apparatus casing according to claim 1, comprising a partition wall (50, 500) which divides the downstream part of the first chamber (20, 200) into a first sub-chamber (25, 250) and a second sub-chamber (26, 260), wherein the first (42, 420) and the second (44, 440) outlet openings are disposed in the first and second sub-chambers respectively.

3. An apparatus casing according to claim 2, wherein the partition wall (500) forms a duct that extends from the second outlet opening (440) into the first chamber (200), wherein the duct constitutes said second sub-chamber (260).

4. An apparatus casing according to any one of claims 1-3, wherein an exhaust fan (45, 450, 51, 510) is provided in or adjacent to each of said first (42, 420) and second (44, 440) outlet openings such as to drive the two sub-flows (F1, F3) through a respective outlet opening.

5. An apparatus casing according to any one of claims 1-4, wherein the two outlet openings (420, 440) open into a second chamber (600) which constitutes a common outlet plenum for the two sub-flows, and wherein the outlet plenum communicates with the outlet duct (410).

6. An apparatus casing according to claim 5, wherein a chanter wall (107) delimits the interior of the casing (100) into the first chamber (200) and the second chamber (600) respectively.

7. An apparatus casing according to claim 6, wherein the two exhaust fans (450, 510) and the partition wall (500) are fixed to the chamber wall (107).

8. An apparatus casing according to any one of claims 1-7, wherein at least one of the casing walls (105, 106) is double-walled, wherein the input duct (310) and/or the outlet duct (410) is/are disposed in the double-walled wall.

9. An apparatus casing according to anyone of claims 1-8, wherein two of the casing walls (105, 106) are double-walled and wherein each of the inlet and outlet ducts (410) is disposed in a respective double-walled wall.

10. An apparatus casing according to claim 8 or 9, wherein the double-walled wall (105) that encloses the inlet duct (310) includes a second inlet opening (360) for limited supply of air to a specific component (A) in the first chamber (200).

11. A computer that includes an apparatus casing according to any one of claims 1-10.

12. A computer according to claim 11, wherein one or more hard discs (B) is/are fixated with the aid of the means for securing a computer component in one of said two mutually separate sub-flows.
